(19) United States
(12) Patent Application Publication
(10) Pub. No.: US 2026/0288062 A1
(43) Pub. Date: Sep. 24, 2026

(54) DC Order Block

(71) Applicant: Envisics Ltd, Milton Keynes (GB)

(72) Inventors: Daniel Burnham, Milton Keynes (GB); Timothy Smeeton, Milton Keynes (GB); Hugo Malin-Clegg, Milton Keynes (GB)

(21) Appl. No.: 19/472,385

(22) PCT Filed: Apr. 15, 2024
(86) PCT No.: PCT/EP2024/060151

§ 371 Date: Oct. 3, 2025

(30) Foreign Application Priority Data
Apr. 17, 2023 (GB) 2305600.5

(51) Int. Cl. G03H 1/22; G03H 1/02

(52) U.S. Cl. CPC G03H 1/2294; G03H 1/02; G03H 1/2205; G03H 2001/0216; G03H 2001/0224; G03H 2001/221; G03H 2223/16; G03H 2225/52; G03H 2250/33; G03H 2270/11

(57) ABSTRACT

A holographic projector configured to provide a holographic picture at an output plane. The holographic projector comprises a spatial light modulator configured to display a hologram such that any light incident on the displayed hologram is spatially modulated according to the displayed hologram. The holographic projector further comprises an optical relay arranged to receive the spatially modulated light, the optical relay comprising a pair of lenses arranged in cooperation to form the holographic picture at the output plane. The holographic projector further comprises a spatial light filter comprising a portion arranged to receive the spatially modulated light. The portion blocks at least a part of the spatially modulated light and the amount of light blocked by the portion decreases as a continuous function of distance relative to a centre of the portion.

### FIELD

The present disclosure relates to a spatial light filter. More specifically, the present disclosure relates to a spatial light filter for a holographic display. Some embodiments relate to a holographic projector, picture generating unit or head-up display.

### BACKGROUND AND INTRODUCTION

Light scattered from an object contains both amplitude and phase information. This amplitude and phase information can be captured on, for example, a photosensitive plate by well-known interference techniques to form a holographic recording, or “hologram”, comprising interference fringes. The hologram may be reconstructed by illumination with suitable light to form a two-dimensional or three-dimensional holographic reconstruction, or replay image, representative of the original object.

Computer-generated holography may numerically simulate the interference process. A computer-generated hologram may be calculated by a technique based on a mathematical transformation such as a Fresnel or Fourier transform. These types of holograms may be referred to as Fresnel/Fourier transform holograms or simply Fresnel/Fourier holograms. A Fourier hologram may be considered a Fourier domain/plane representation of the object or a frequency domain/plane representation of the object. A computer-generated hologram may also be calculated by coherent ray tracing or a point cloud technique, for example.

A computer-generated hologram may be encoded on a spatial light modulator arranged to modulate the amplitude and/or phase of incident light. Light modulation may be achieved using electrically-addressable liquid crystals, optically-addressable liquid crystals or micro-mirrors, for example.

A spatial light modulator typically comprises a plurality of individually-addressable pixels which may also be referred to as cells or elements. The light modulation scheme may be binary, multilevel or continuous. Alternatively, the device may be continuous (i.e. is not comprised of pixels) and light modulation may therefore be continuous across the device. The spatial light modulator may be reflective meaning that modulated light is output in reflection. The spatial light modulator may equally be transmissive meaning that modulated light is output in transmission.

A holographic projector may be provided using the system described herein. Such projectors have found application in head-up displays, “HUD”.

### SUMMARY

Aspects of the present disclosure are defined in the appended independent claims.

In an aspect, there is provided a holographic projector configured to provide a holographic picture at an output plane. The holographic projector comprises a spatial light modulator and an optical relay. The spatial light modulator is configured to display a hologram such that light incident on the displayed hologram is spatially modulated according to the displayed hologram. The optical relay is arranged to receive (the output light of the spatial light modulator including) the spatially modulated light. The optical relay comprises a pair of lenses arranged in cooperation to form the holographic picture at the output plane, and a spatial light filter comprising a portion arranged to receive the (output light of the spatial light modulator including the) spatially modulated light, wherein the portion has a transmissivity that changes (e.g. increases) as a continuous function of distance relative to a centre of the portion. The output light (of the spatial light modulator) may comprise spatially modulated light and other light such as specularly-reflected light. The term “spatially modulated light” is not used strictly in this disclosure and instead generally refers to all the output light of the spatial light modulator, including the specularly-reflected component, unless stated otherwise.

In yet another aspect, there is provided a holographic projector configured to provide a holographic picture at an output plane. The holographic projector comprises: a spatial light modulator configured to display a hologram such that any light incident on the displayed hologram is spatially modulated according to the displayed hologram, an optical relay arranged to receive the spatially modulated light, the optical relay comprising a pair of lenses arranged in cooperation to form the holographic picture at the output plane, and a spatial light filter comprising a portion arranged to receive the spatially modulated light, wherein the portion blocks an amount of the received spatially modulated light. In particular, the portion blocks an amount of light from continuing to propagate along an optical path of the optical relay. It may be said that the portion removes an amount of light from the optical path of the optical relay downstream of the spatial light filter. The amount of light blocked by the portion decreases as a continuous function of distance relative to a centre of the portion. The blocking (or removal) may be achieved by absorption or reflectance.

There is disclosed herein a holographic projector comprising a spatial light modulator and an optical relay. The spatial light modulator is arranged to (output light including) spatially modulate light in accordance with a hologram of a picture displayed thereon. The optical relay is arranged to receive the (output light including) spatially modulated light. The optical relay comprises a pair of lens and a spatial filter. The pair of lenses is arranged in cooperation to form an image of the hologram at an output plane. The spatial filter is disposed at an intermediate plane between the pair of lens. The spatial filter comprises a first area arranged to receive a DC component of the output light/spatially modulated light and a second area. The first area has a first transmissivity that is a function of distance from its centre. The second area has a second transmissivity that is substantially constant. The function may be substantially continuous, non-linear, have a finite gradient and/or comprise a Gaussian function. In some embodiments, the function has a rate of change of transmissivity that does not exceed 10% per 100 microns. The spatial filter is arranged to prevent the DC component of the output light/spatially modulated light from propagating to the output plane of the optical relay. The DC component corresponds to non-picture content of the output light/spatially modulated light such as unmodulated light from the spatial light modulator. The intermediate plane is a focal plane (of the first lens of the pair of lenses).

The spatial light filter may be arranged to receive a DC order component or secondary component of the spatially modulated light. The portion may be the whole of the spatial light filter. The portion may be a subsection of the spatial light filter. Light incident on such a spatial light filter may have an entry intensity. As the light incident on the spatial light filter propagates through the spatial light filter, the intensity of that light decreases. The light exiting the spatial light filter (after having propagated through the spatial light filter) may have an exit intensity. The exit intensity and/or the difference between the entry and exit intensities may depend on the transmissivity of the spatial light filter and/or the thickness of the spatial light filter through which the light propagates. A higher transmissivity results in a smaller amount of difference between incident intensity and exit intensity. A lower transmissivity results in a larger amount of difference between incident intensity and exit intensity. The centre of the portion may be a centre of the spatial light filter. The transmissivity at the centre of the portion may be a minimum value of the function. The transmissivity at the centre of the portion may be less than or equal to 10%. The transmissivity at the centre of the portion may be less than or equal to 5%.

The holographic projector may further comprise a further portion that has a further transmissivity that is substantially constant. The further transmissivity may be a maximum or minimum value of the continuous function.

The further transmissivity may be greater than or equal to 90%. The further transmissivity may be greater than or equal to 95%. The further transmissivity may be a maximum value of the continuous function. The further portion may have a substantially constant transmissivity throughout the further portion. Transmissivity may be expressed as a percentage. The transmissivity at 100% may mean fully transparent. In other words, the portion having 100% transmissivity may allow light to pass through unhindered. Light passing through the portion having 100% transmissivity would not reduce in intensity. The transmissivity at 0% may mean fully opaque. In other words, the portion having 0% transmissivity may block all of the light from passing through that portion. Light trying to pass through the portion having 0% transmissivity may not immerge from that portion. A portion having a transmissivity that is between 100% and 0% may mean that only some of the light is allowed to pass through that portion and some of the light is blocked by that portion.

The function may have a maximum rate of change of transmissivity that is less than or equal to 10% per 100 microns. The maximum rate of change of transmissivity may be less than or equal to 5% per 100 microns. The rate of change of transmissivity may be 5% per 20 microns. The rate of change of transmissivity may be 5% per 2.5 microns.

The rate of change of transmissivity may be the gradient of the function. The rate of change of transmissivity may mean that the transmissivity increases by an additional percentage as the distance from the centre increases by a certain micron. For example, a rate of change of transmissivity is 10% per 100 microns means that the transmissivity increases or decreases by 10% when the distance (as measured from the centre of the portion) increases or decreases by 100 microns respectively. The rate of change of transmissivity may also be dependent on the distance from the centre of the portion. In other words, the rate of change of transmissivity may not be a constant value throughout the spatial light filter. The rate of change of transmissivity at a value that is half of the maximum value of the function may be less than 5% per 100 microns.

In yet another aspect, there is provided a holographic projector configured to provide a holographic picture at an output plane. The holographic projector comprises: a spatial light modulator configured to display a hologram such that any light incident on the displayed hologram is spatially modulated according to the displayed hologram; an optical relay arranged to receive the spatially modulated light, the optical relay comprising a pair of lenses arranged in cooperation to form the holographic picture at the output plane; and a spatial light filter comprising a portion arranged to receive the spatially modulated light, wherein the portion has a reflectivity that changes (e.g., increases or decreases) as a continuous function of distance relative to a centre of the portion.

Light incident on such a spatial light filter may have an incident intensity. The light incident on the spatial light filter may be then reflected off the spatial light filter with a reflected intensity. The reflected intensity and/or the difference between the incident intensity and the reflected intensity may be dependent on the reflectivity of the spatial light filter. A higher reflectivity may result in a smaller difference between incident and reflected intensities. A lower reflectivity may result in a lager difference between incident and reflected intensities.

The holographic projector may further comprise a further portion that has a further reflectivity that is substantially constant. The further reflectivity may be a maximum value of the continuous function.

The further reflectivity may be greater than or equal to 5%. The further reflectivity may be greater than or equal to 10%. The further reflectivity may be a minimum value of the continuous function. The further portion may be a substantially constant transmissivity throughout the further portion. Reflectivity may be expressed as a percentage. The reflectivity at 100% may mean fully reflective. In other words, the portion having 100% reflectivity allows light to be reflected without losing any intensity. The reflectivity at 0% may mean not reflective. In other words, the portion having 0% reflectivity does not reflect light, i.e. the intensity of the reflected light would be zero. A portion having a reflectivity that is between 100% and 0% may mean that only some amount of the light is reflected.

The function may have a rate of change of reflectivity that is less than or equal to 10% per 100 microns. The rate of change of reflectivity may be less than or equal to 5% per 100 microns. The rate of change of reflectivity may be 5% per 20 microns. The rate of change of reflectivity may be 5% per 2.5 microns.

The rate of change of reflectivity may be the gradient of the function. The rate of change of reflectivity may mean that the reflectivity increases or decreases by an additional percentage as the distance increases by a certain micron. For example, a rate of change of reflectivity may be less than or equal to 10% per 100 microns means that the reflectivity increases or decreases by 10% when the distance (as measured from the centre of the portion) increases or decreases by 100 microns respectively. The rate of change of reflectivity may also be dependent on the distance from the centre of the portion. In other words, the rate of change of reflectivity may not be a constant value throughout the spatial light filter.

The continuous function may be non-linear. The continuous function may be a Gaussian function. The continuous function may be linear.

The portion may be substantially elongated in one dimension. The portion may be oval or elliptical in shape. The portion may be circular in shape. The portion may have an area that is substantially elongated in one dimension in order to increase alignment tolerance in the one dimension compared to the perpendicular direction. This can be advantageous in some applications-such as automotive head-up display-in which one dimension is susceptible to translational movement, such as vibration, during use.

The spatial light filter may be positioned at a focal plane of one lens of the pair of lenses. The spatial light filter may be arranged to prevent a portion of the spatially modulated light from propagating to the output plane of the optical relay. The portion may be the DC or secondary component of the spatially modulated light (more specifically, the DC or secondary component of the output light). The portion of the spatially modulated light may correspond to a non-picture content of the spatially modulated light, such as unmodulated light from the spatial light modulator. At least one waveguide may be arranged to receive the spatially modulated light.

In yet another aspect, there is provided a method of manufacturing a spatial light filter for a holographic projector. The method comprises applying a light absorption coating having a first transmissivity onto a material having a second transmissivity higher than the first transmissivity. The application of the light absorption coating is such that the resulting spatial light filter has a portion that has a transmissivity that increases as a continuous function of distance relative to a centre of the portion.

The application of the light absorption coating may be such that the spatial light filter has a further portion that has a further transmissivity that is substantially constant. The portions of lower transmissivity may have a larger amount of the absorption coating applied thereon. The thickness and/or density and/or concentration of the absorption coating may be greater at areas of lower transmissivity. The thickness and/or density and/or concentration of the absorption coating may be lower at areas of higher transmissivity.

The method may further comprise positioning a mirror on a further surface of the material opposing the surface having the absorption coating applied thereon. The material may be glass.

In yet another aspect, there is provided a method of manufacturing a spatial light filter. The method comprises applying a coating to a material, the coated material creating a reflective surface. The application of the coating is arranged such that the spatial light filter has a portion that has a reflectivity that increases as a continuous function of distance relative to a centre of the portion.

The portions of lower reflectance may have a lower amount of the reflectance coating applied thereon. The thickness and/or density and/or concentration of the reflectance coating may be greater at areas of higher reflectance. The thickness and/or density and/or concentration of the reflectance coating may be lower at areas of lower reflectance. The material may be glass.

In the present disclosure, the term “replica” is merely used to reflect that spatially modulated light is divided such that a complex light field is directed along a plurality of different optical paths. The word “replica” is used to refer to each occurrence or instance of the complex light field after a replication event —such as a partial reflection-transmission by a pupil expander. Each replica travels along a different optical path. Some embodiments of the present disclosure relate to propagation of light that is encoded with a hologram, not an image—i.e., light that is spatially modulated with a hologram of an image, not the image itself. It may therefore be said that a plurality of replicas of the hologram are formed. The person skilled in the art of holography will appreciate that the complex light field associated with propagation of light encoded with a hologram will change with propagation distance. Use herein of the term “replica” is independent of propagation distance and so the two branches or paths of light associated with a replication event are still referred to as “replicas” of each other even if the branches are a different length, such that the complex light field has evolved differently along each path. That is, two complex light fields are still considered “replicas” in accordance with this disclosure even if they are associated with different propagation distances-providing they have arisen from the same replication event or series of replication events.

A “diffracted light field” or “diffractive light field” in accordance with this disclosure is a light field formed by diffraction. A diffracted light field may be formed by illuminating a corresponding diffractive pattern. In accordance with this disclosure, an example of a diffractive pattern is a hologram and an example of a diffracted light field is a holographic light field or a light field forming a holographic reconstruction of an image. The holographic light field forms a (holographic) reconstruction of an image on a replay plane. The holographic light field that propagates from the hologram to the replay plane may be said to comprise light encoded with the hologram or light in the hologram domain. A diffracted light field is characterized by a diffraction angle determined by the smallest feature size of the diffractive structure and the wavelength of the light (of the diffracted light field). In accordance with this disclosure, it may also be said that a “diffracted light field” is a light field that forms a reconstruction on a plane spatially separated from the corresponding diffractive structure. An optical system is disclosed herein for propagating a diffracted light field from a diffractive structure to a viewer. The diffracted light field may form an image.

The term “hologram” is used to refer to the recording which contains amplitude information or phase information, or some combination thereof, regarding the object. The term “holographic reconstruction” is used to refer to the optical reconstruction of the object which is formed by illuminating the hologram. The system disclosed herein is described as a “holographic projector” because the holographic reconstruction is a real image and spatially-separated from the hologram. The term “replay field” is used to refer to the 2D area within which the holographic reconstruction is formed and fully focused. If the hologram is displayed on a spatial light modulator comprising pixels, the replay field will be repeated in the form of a plurality diffracted orders wherein each diffracted order is a replica of the zeroth-order replay field. The zeroth-order replay field generally corresponds to the preferred or primary replay field because it is the brightest replay field. Unless explicitly stated otherwise, the term “replay field” should be taken as referring to the zeroth-order replay field. The term “replay plane” is used to refer to the plane in space containing all the replay fields. The terms “image”, “replay image” and “image region” refer to areas of the replay field illuminated by light of the holographic reconstruction. In some embodiments, the “image” may comprise discrete spots which may be referred to as “image spots” or, for convenience only, “image pixels”.

The terms “encoding”, “writing” or “addressing” are used to describe the process of providing the plurality of pixels of the SLM with a respective plurality of control values which respectively determine the modulation level of each pixel. It may be said that the pixels of the SLM are configured to “display” a light modulation distribution in response to receiving the plurality of control values. Thus, the SLM may be said to “display” a hologram and the hologram may be considered an array of light modulation values or levels.

It has been found that a holographic reconstruction of acceptable quality can be formed from a “hologram” containing only phase information related to the Fourier transform of the original object. Such a holographic recording may be referred to as a phase-only hologram. Embodiments relate to a phase-only hologram but the present disclosure is equally applicable to amplitude-only holography.

The present disclosure is also equally applicable to forming a holographic reconstruction using amplitude and phase information related to the Fourier transform of the original object. In some embodiments, this is achieved by complex modulation using a so-called fully complex hologram which contains both amplitude and phase information related to the original object. Such a hologram may be referred to as a fully-complex hologram because the value (grey level) assigned to each pixel of the hologram has an amplitude and phase component. The value (grey level) assigned to each pixel may be represented as a complex number having both amplitude and phase components. In some embodiments, a fully-complex computer-generated hologram is calculated.

Reference may be made to the phase value, phase component, phase information or, simply, phase of pixels of the computer-generated hologram or the spatial light modulator as shorthand for “phase-delay”. That is, any phase value described is, in fact, a number (e.g. in the range 0 to 2π) which represents the amount of phase retardation provided by that pixel. For example, a pixel of the spatial light modulator described as having a phase value of π/2 will retard the phase of received light by π/2 radians. In some embodiments, each pixel of the spatial light modulator is operable in one of a plurality of possible modulation values (e.g. phase delay values). The term “grey level” may be used to refer to the plurality of available modulation levels. For example, the term “grey level” may be used for convenience to refer to the plurality of available phase levels in a phase-only modulator even though different phase levels do not provide different shades of grey. The term “grey level” may also be used for convenience to refer to the plurality of available complex modulation levels in a complex modulator.

The hologram therefore comprises an array of grey levels—that is, an array of light modulation values such as an array of phase-delay values or complex modulation values. The hologram is also considered a diffractive pattern because it is a pattern that causes diffraction when displayed on a spatial light modulator and illuminated with light having a wavelength comparable to, generally less than, the pixel pitch of the spatial light modulator. Reference is made herein to combining the hologram with other diffractive patterns such as diffractive patterns functioning as a lens or grating. For example, a diffractive pattern functioning as a grating may be combined with a hologram to translate the replay field on the replay plane or a diffractive pattern functioning as a lens may be combined with a hologram to focus the holographic reconstruction on a replay plane in the near field.

Although different embodiments and groups of embodiments may be disclosed separately in the detailed description which follows, any feature of any embodiment or group of embodiments may be combined with any other feature or combination of features of any embodiment or group of embodiments. That is, all possible combinations and permutations of features disclosed in the present disclosure are envisaged.

### BRIEF DESCRIPTION OF THE DRAWINGS

Specific embodiments are described by way of example only with reference to the following figures:

FIG. 1 is a schematic showing a reflective SLM producing a holographic reconstruction on a screen;

FIG. 2 shows an image for projection comprising eight image areas/components, V1 to V8, and cross-sections of the corresponding hologram channels, H1-H8;

FIG. 3 shows a hologram displayed on an LCOS that directs light into a plurality of discrete areas;

FIG. 4 shows a system, including a display device that displays a hologram that has been calculated as illustrated in FIGS. 2 and 3;

FIG. 5A shows a perspective view of a first example two-dimensional pupil expander comprising two replicators each comprising pairs of stacked surfaces;

FIG. 5B shows a perspective view of a first example two-dimensional pupil expander comprising two replicators each in the form of a solid waveguide;

FIG. 6A depicts an intensity plot of light propagating through a DC order ‘hole’ or step-function hole and arriving at the SLM/hologram image;

FIG. 6B depicts a phase plot of light propagating through a DC order ‘hole’ or step-function hole and arriving at the SLM/hologram image;

FIG. 6C depicts an intensity plot of the image constructed from light propagating through a DC order ‘hole or step-function hole when a blank/zero hologram is relayed;

FIG. 7 depicts a transmission profile of a spatial light filter having a Gaussian hole or a hole having a Gaussian profile;

FIG. 8A depicts an intensity plot of light propagating through a spatial light filter having an elliptical Gaussian hole and arriving at the SLM/hologram image;

FIG. 8B depicts a phase plot of light propagating through a spatial light filter having an elliptical Gaussian hole and arriving at the SLM/hologram image; and

FIG. 8C depicts an intensity plot of the hologram constructed from light propagating through an elliptical Gaussian hole when a blank/zero hologram is relayed.

The same reference numbers will be used throughout the drawings to refer to the same or like parts.

### DETAILED DESCRIPTION OF EMBODIMENTS

The present invention is not restricted to the embodiments described in the following but extends to the full scope of the appended claims. That is, the present invention may be embodied in different forms and should not be construed as limited to the described embodiments, which are set out for the purpose of illustration.

Terms of a singular form may include plural forms unless specified otherwise.

A structure described as being formed at an upper portion/lower portion of another structure or on/under the other structure should be construed as including a case where the structures contact each other and, moreover, a case where a third structure is disposed there between.

In describing a time relationship—for example, when the temporal order of events is described as “after”, “subsequent”, “next”, “before” or suchlike—the present disclosure should be taken to include continuous and non-continuous events unless otherwise specified. For example, the description should be taken to include a case which is not continuous unless wording such as “just”, “immediate” or “direct” is used.

Although the terms “first”, “second”, etc. may be used herein to describe various elements, these elements are not to be limited by these terms. These terms are only used to distinguish one element from another. For example, a first element could be termed a second element, and, similarly, a second element could be termed a first element, without departing from the scope of the appended claims.

Features of different embodiments may be partially or overall coupled to or combined with each other, and may be variously inter-operated with each other. Some embodiments may be carried out independently from each other, or may be carried out together in co-dependent relationship.

In the present disclosure, the term “substantially” when applied to a structural units of an apparatus may be interpreted as the technical feature of the structural units being produced within the technical tolerance of the method used to manufacture it.

### Conventional Optical Configuration for Holographic Projection

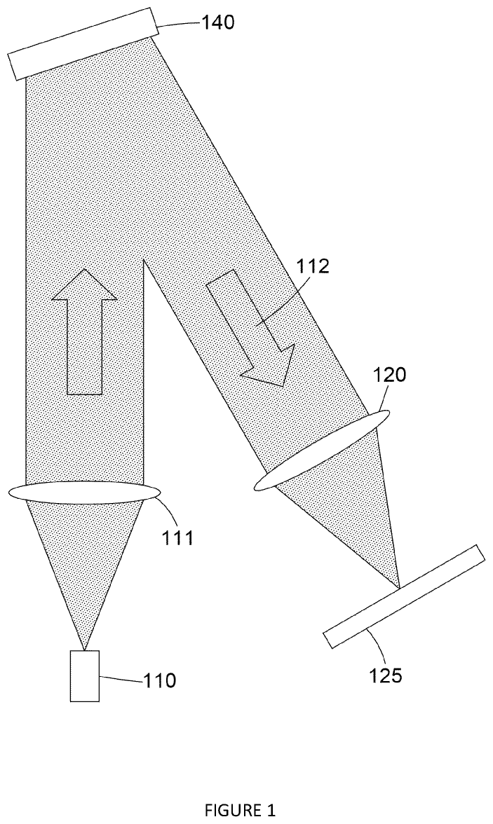

FIG. 1 shows an embodiment in which a computer-generated hologram is encoded on a single spatial light modulator. The computer-generated hologram is a Fourier transform of the object for reconstruction. It may therefore be said that the hologram is a Fourier domain or frequency domain or spectral domain representation of the object. In this embodiment, the spatial light modulator is a reflective liquid crystal on silicon, “LCOS”, device. The hologram is encoded on the spatial light modulator and a holographic reconstruction is formed at a replay field, for example, a light receiving surface such as a screen or diffuser.

A light source 110, for example a laser or laser diode, is disposed to illuminate the SLM 140 via a collimating lens 111. The collimating lens causes a generally planar wavefront of light to be incident on the SLM. In FIG. 1, the direction of the wavefront is off-normal (e.g. two or three degrees away from being truly orthogonal to the plane of the transparent layer). However, in other embodiments, the generally planar wavefront is provided at normal incidence and a beam splitter arrangement is used to separate the input and output optical paths. In the embodiment shown in FIG. 1, the arrangement is such that light from the light source is reflected off a mirrored rear surface of the SLM and interacts with a light-modulating layer to form an exit wavefront 112. The exit wavefront 112 is applied to optics including a Fourier transform lens 120, having its focus at a screen 125. More specifically, the Fourier transform lens 120 receives a beam of modulated light from the SLM 140 and performs a frequency-space transformation to produce a holographic reconstruction at the screen 125.

Notably, in this type of holography, each pixel of the hologram contributes to the whole reconstruction. There is not a one-to-one correlation between specific points (or image pixels) on the replay field and specific light-modulating elements (or hologram pixels). In other words, modulated light exiting the light-modulating layer is distributed across the replay field.

In these embodiments, the position of the holographic reconstruction in space is determined by the dioptric (focusing) power of the Fourier transform lens. In the embodiment shown in FIG. 1, the Fourier transform lens is a physical lens. That is, the Fourier transform lens is an optical Fourier transform lens and the Fourier transform is performed optically. Any lens can act as a Fourier transform lens but the performance of the lens will limit the accuracy of the Fourier transform it performs. The skilled person understands how to use a lens to perform an optical Fourier transform In some embodiments of the present disclosure, the lens of the viewer's eye performs the hologram to image transformation.

### Hologram Calculation

In some embodiments, the computer-generated hologram is a Fourier transform hologram, or simply a Fourier hologram or Fourier-based hologram, in which an image is reconstructed in the far field by utilising the Fourier transforming properties of a positive lens. The Fourier hologram is calculated by Fourier transforming the desired light field in the replay plane back to the lens plane. Computer-generated Fourier holograms may be calculated using Fourier transforms. Embodiments relate to Fourier holography and Gerchberg-Saxton type algorithms by way of example only. The present disclosure is equally applicable to Fresnel holography and Fresnel holograms which may be calculated by a similar method. In some embodiments, the hologram is a phase or phase-only hologram. However, the present disclosure is also applicable to holograms calculated by other techniques such as those based on point cloud methods.

In some embodiments, the hologram engine is arranged to exclude from the hologram calculation the contribution of light blocked by a limiting aperture of the display system. British patent application 2101666.2, filed 5 Feb. 2021 and incorporated herein by reference, discloses a first hologram calculation method in which eye-tracking and ray tracing are used to identify a sub-area of the display device for calculation of a point cloud hologram which eliminates ghost images. The sub-area of the display device corresponds with the aperture, of the present disclosure, and is used exclude light paths from the hologram calculation. British patent application 2112213.0, filed 26 Aug. 2021 and incorporated herein by reference, discloses a second method based on a modified Gerchberg-Saxton type algorithm which includes steps of light field cropping in accordance with pupils of the optical system during hologram calculation. The cropping of the light field corresponds with the determination of a limiting aperture of the present disclosure. British patent application 2118911.3, filed 23 Dec. 2021 and also incorporated herein by reference, discloses a third method of calculating a hologram which includes a step of determining a region of a so-called extended modulator formed by a hologram replicator. The region of the extended modulator is also an aperture in accordance with this disclosure. In some embodiments, there is provided a real-time engine arranged to receive image data and calculate holograms in real-time using the algorithm. In some embodiments, the image data is a video comprising a sequence of image frames. In other embodiments, the holograms are pre-calculated, stored in computer memory and recalled as needed for display on a SLM. That is, in some embodiments, there is provided a repository of predetermined holograms.

### Large Field of View Using Small Display Device

Broadly, the present disclosure relates to image projection. It relates to a method of image projection and an image projector which comprises a display device. The present disclosure also relates to a projection system comprising the image projector and a viewing system, in which the image projector projects or relays light from the display device to the viewing system. The present disclosure is equally applicable to a monocular and binocular viewing system. The viewing system may comprise a viewer's eye or eyes. The viewing system comprises an optical element having optical power (e.g., lens/es of the human eye) and a viewing plane (e.g., retina of the human eye/s). The projector may be referred to as a ‘light engine’. The display device and the image formed (or perceived) using the display device are spatially separated from one another. The image is formed, or perceived by a viewer, on a display plane. In some embodiments, the image is a virtual image and the display plane may be referred to as a virtual image plane. In other examples, the image is a real image formed by holographic reconstruction and the image is projected or relayed to the viewing plane. In these other examples, spatially modulated light of an intermediate holographic reconstruction formed either in free space or on a screen or other light receiving surface between the display device and the viewer, is propagated to the viewer. In both cases, an image is formed by illuminating a diffractive pattern (e.g., hologram or kinoform) displayed on the display device.

The display device comprises pixels. The pixels of the display may display a diffractive pattern or structure that diffracts light. The diffracted light may form an image at a plane spatially separated from the display device. In accordance with well-understood optics, the magnitude of the maximum diffraction angle is determined by the size of the pixels and other factors such as the wavelength of the light.

In embodiments, the display device is a spatial light modulator such as liquid crystal on silicon (“LCOS”) spatial light modulator (SLM). Light propagates over a range of diffraction angles (for example, from zero to the maximum diffractive angle) from the LCOS, towards a viewing entity/system such as a camera or an eye. In some embodiments, magnification techniques may be used to increase the range of available diffraction angles beyond the conventional maximum diffraction angle of an LCOS.

In some embodiments, the (light of a) hologram itself is propagated to the eyes. For example, spatially modulated light of the hologram (that has not yet been fully transformed to a holographic reconstruction, i.e. image)—that may be informally said to be “encoded” with/by the hologram—is propagated directly to the viewer's eyes. A real or virtual image may be perceived by the viewer. In these embodiments, there is no intermediate holographic reconstruction/image formed between the display device and the viewer. It is sometimes said that, in these embodiments, the lens of the eye performs a hologram-to-image conversion or transform. The projection system, or light engine, may be configured so that the viewer effectively looks directly at the display device.

Reference is made herein to a “light field” which is a “complex light field”. The term “light field” merely indicates a pattern of light having a finite size in at least two orthogonal spatial directions, e.g. x and y.

The word “complex” is used herein merely to indicate that the light at each point in the light field may be defined by an amplitude value and a phase value, and may therefore be represented by a complex number or a pair of values. For the purpose of hologram calculation, the complex light field may be a two-dimensional array of complex numbers, wherein the complex numbers define the light intensity and phase at a plurality of discrete locations within the light field.

In accordance with the principles of well-understood optics, the range of angles of light propagating from a display device that can be viewed, by an eye or other viewing entity/system, varies with the distance between the display device and the viewing entity. At a 1 metre viewing distance, for example, only a small range of angles from an LCOS can propagate through an eye's pupil to form an image at the retina for a given eye position. The range of angles of light rays that are propagated from the display device, which can successfully propagate through an eye's pupil to form an image at the retina for a given eye position, determines the portion of the image that is ‘visible’ to the viewer. In other words, not all parts of the image are visible from any one point on the viewing plane (e.g., any one eye position within a viewing window such as eye-box.)

In some embodiments, the image perceived by a viewer is a virtual image that appears upstream of the display device—that is, the viewer perceives the image as being further away from them than the display device. Conceptually, it may therefore be considered that the viewer is looking at a virtual image through an ‘display device-sized window’, which may be very small, for example 1 cm in diameter, at a relatively large distance, e.g., 1 metre. And the user will be viewing the display device-sized window via the pupil(s) of their eye(s), which can also be very small. Accordingly, the field of view becomes small and the specific angular range that can be seen depends heavily on the eye position, at any given time.

A pupil expander addresses the problem of how to increase the range of angles of light rays that are propagated from the display device that can successfully propagate through an eye's pupil to form an image. The display device is generally (in relative terms) small and the projection distance is (in relative terms) large. In some embodiments, the projection distance is at least one—such as, at least two-orders of magnitude greater than the diameter, or width, of the entrance pupil and/or aperture of the display device (i.e., size of the array of pixels).

Use of a pupil expander increases the viewing area (i.e., user's eye-box) laterally, thus enabling some movement of the eye/s to occur, whilst still enabling the user to see the image. As the skilled person will appreciate, in an imaging system, the viewing area (user's eye box) is the area in which a viewer's eyes can perceive the image. The present disclosure encompasses non-infinite virtual image distances—that is, near-field virtual images.

Conventionally, a two-dimensional pupil expander comprises one or more one-dimensional optical waveguides each formed using a pair of opposing reflective surfaces, in which the output light from a surface forms a viewing window or eye-box. Light received from the display device (e.g., spatially modulated light from a LCOS) is replicated by the or each waveguide so as to increase the field of view (or viewing area) in at least one dimension. In particular, the waveguide enlarges the viewing window due to the generation of extra rays or “replicas” by division of amplitude of the incident wavefront.

The display device may have an active or display area having a first dimension that may be less than 10 cms such as less than 5 cms or less than 2 cms. The propagation distance between the display device and viewing system may be greater than 1 m such as greater than 1.5 m or greater than 2 m. The optical propagation distance within the waveguide may be up to 2 m such as up to 1.5 m or up to 1 m. The method may be capable of receiving an image and determining a corresponding hologram of sufficient quality in less than 20 ms such as less than 15 ms or less than 10 ms.

In some embodiments—described only by way of example of a diffracted or holographic light field in accordance with this disclosure—a hologram is configured to route light into a plurality of channels, each channel corresponding to a different part (i.e. sub-area) of an image. The channels formed by the diffractive structure are referred to herein as “hologram channels” merely to reflect that they are channels of light encoded by the hologram with image information. It may be said that the light of each channel is in the hologram domain rather than the image or spatial domain. In some embodiments, the hologram is a Fourier or Fourier transform hologram and the hologram domain is therefore the Fourier or frequency domain. The hologram may equally be a Fresnel or Fresnel transform hologram. The hologram may also be a point cloud hologram. The hologram is described herein as routing light into a plurality of hologram channels to reflect that the image that can be reconstructed from the hologram has a finite size and can be arbitrarily divided into a plurality of image sub-areas, wherein each hologram channel would correspond to each image sub-area. Importantly, the hologram of this example is characterised by how it distributes the image content when illuminated. Specifically and uniquely, the hologram divides the image content by angle. That is, each point on the image is associated with a unique light ray angle in the spatially modulated light formed by the hologram when illuminated—at least, a unique pair of angles because the hologram is two-dimensional. For the avoidance of doubt, this hologram behaviour is not conventional. The spatially modulated light formed by this special type of hologram, when illuminated, may be divided into a plurality of hologram channels, wherein each hologram channel is defined by a range of light ray angles (in two-dimensions). It will be understood from the foregoing that any hologram channel (i.e. sub-range of light ray angles) that may be considered in the spatially modulated light will be associated with a respective part or sub-area of the image. That is, all the information needed to reconstruct that part or sub-area of the image is contained within a sub-range of angles of the spatially modulated light formed from the hologram of the image. When the spatially modulated light is observed as a whole, there is not necessarily any evidence of a plurality of discrete light channels.

Nevertheless, the hologram may still be identified. For example, if only a continuous part or sub-area of the spatially modulated light formed by the hologram is reconstructed, only a sub-area of the image should be visible. If a different, continuous part or sub-area of the spatially modulated light is reconstructed, a different sub-area of the image should be visible. A further identifying feature of this type of hologram is that the shape of the cross-sectional area of any hologram channel substantially corresponds to (i.e. is substantially the same as) the shape of the entrance pupil although the size may be different—at least, at the correct plane for which the hologram was calculated. Each light/hologram channel propagates from the hologram at a different angle or range of angles. Whilst these are example ways of characterising or identifying this type of hologram, other ways may be used. In summary, the hologram disclosed herein is characterised and identifiable by how the image content is distributed within light encoded by the hologram. Again, for the avoidance of any doubt, reference herein to a hologram configured to direct light or angularly-divide an image into a plurality of hologram channels is made by way of example only and the present disclosure is equally applicable to pupil expansion of any type of holographic light field or even any type of diffractive or diffracted light field.

The system can be provided in a compact and streamlined physical form. This enables the system to be suitable for a broad range of real-world applications, including those for which space is limited and real-estate value is high. For example, it may be implemented in a head-up display (HUD) such as a vehicle or automotive HUD.

In accordance with the present disclosure, pupil expansion is provided for diffracted or diffractive light, which may comprise diverging ray bundles. The diffracted light field may be defined by a “light cone”. Thus, the size of the diffracted light field (as defined on a two-dimensional plane) increases with propagation distance from the corresponding diffractive structure (i.e. display device). It can be said that the pupil expander/s replicate the hologram or form at least one replica of the hologram, to convey that the light delivered to the viewer is spatially modulated in accordance with a hologram.

In some embodiments, two one-dimensional waveguide pupil expanders are provided, each one-dimensional waveguide pupil expander being arranged to effectively increase the size of the exit pupil of the system by forming a plurality of replicas or copies of the exit pupil (or light of the exit pupil) of the spatial light modulator. The exit pupil may be understood to be the physical area from which light is output by the system. It may also be said that each waveguide pupil expander is arranged to expand the size of the exit pupil of the system. It may also be said that each waveguide pupil expander is arranged to expand/increase the size of the eye box within which a viewer's eye can be located, in order to see/receive light that is output by the system.

### Light Channelling

The hologram formed in accordance with some embodiments, angularly-divides the image content to provide a plurality of hologram channels which may have a cross-sectional shape defined by an aperture of the optical system. The hologram is calculated to provide this channelling of the diffracted light field. In some embodiments, this is achieved during hologram calculation by considering an aperture (virtual or real) of the optical system, as described above.

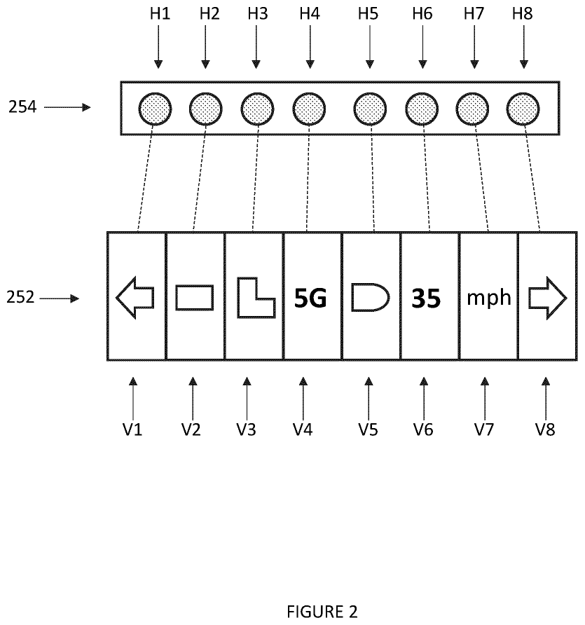

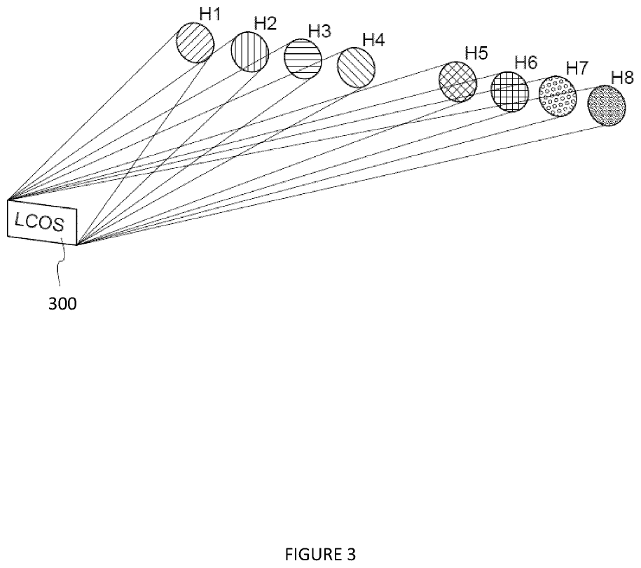

FIGS. 2 and 3 show an example of this type of hologram that may be used in conjunction with a pupil expander as disclosed herein. However, this example should not be regarded as limiting with respect to the present disclosure.

FIG. 2 shows an image 252 for projection comprising eight image areas/components, V1 to V8. FIG. 2 shows eight image components by way of example only and the image 252 may be divided into any number of components. FIG. 2 also shows an encoded light pattern 254 (i.e., hologram) that can reconstruct the image 252—e.g., when transformed by the lens of a suitable viewing system. The encoded light pattern 254 comprises first to eighth sub-holograms or components, H1 to H8, corresponding to the first to eighth image components/areas, V1 to V8. FIG. 2 further shows how a hologram may decompose the image content by angle. The hologram may therefore be characterised by the channelling of light that it performs. This is illustrated in FIG. 3. Specifically, the hologram in this example directs light into a plurality of discrete areas. The discrete areas are discs in the example shown but other shapes are envisaged. The size and shape of the optimum disc may, after propagation through the waveguide, be related to the size and shape of an aperture of the optical system such as the entrance pupil of the viewing system.

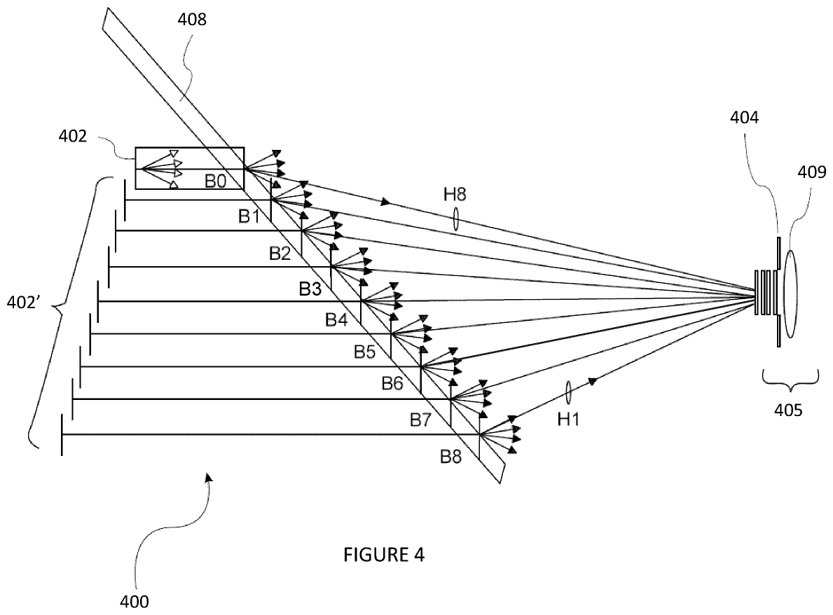

FIG. 4 shows a system 400, including a display device that displays a hologram that has been calculated as illustrated in FIGS. 2 and 3.

The system 400 comprises a display device, which in this arrangement comprises an LCOS 402. The LCOS 402 is arranged to display a modulation pattern (or ‘diffractive pattern’) comprising the hologram and to project light that has been holographically encoded towards an eye 405 that comprises a pupil that acts as an aperture 404, a lens 409, and a retina (not shown) that acts as a viewing plane. There is a light source (not shown) arranged to illuminate the LCOS 402. The lens 409 of the eye 405 performs a hologram-to-image transformation. The light source may be of any suitable type. For example, it may comprise a laser light source.

The viewing system 400 further comprises a waveguide 408 positioned between the LCOS 402 and the eye 405. The presence of the waveguide 408 enables all angular content from the LCOS 402 to be received by the eye, even at the relatively large projection distance shown. This is because the waveguide 508 acts as a pupil expander, in a manner that is well known and so is described only briefly herein.

In brief, the waveguide 408 shown in FIG. 4 comprises a substantially elongate formation. In this example, the waveguide 408 comprises an optical slab of refractive material, but other types of waveguide are also well known and may be used. The waveguide 408 is located so as to intersect the light cone (i.e., the diffracted light field) that is projected from the LCOS 402, for example at an oblique angle. In this example, the size, location, and position of the waveguide 408 are configured to ensure that light from each of the eight ray bundles, within the light cone, enters the waveguide 408. Light from the light cone enters the waveguide 408 via its first planar surface (located nearest the LCOS 402) and is guided at least partially along the length of the waveguide 408, before being emitted via its second planar surface, substantially opposite the first surface (located nearest the eye). As will be well understood, the second planar surface is partially reflective, partially transmissive. In other words, when each ray of light travels within the waveguide 408 from the first planar surface and hits the second planar surface, some of the light will be transmitted out of the waveguide 408 and some will be reflected by the second planar surface, back towards the first planar surface. The first planar surface is reflective, such that all light that hits it, from within the waveguide 408, will be reflected back towards the second planar surface. Therefore, some of the light may simply be refracted between the two planar surfaces of the waveguide 408 before being transmitted, whilst other light may be reflected, and thus may undergo one or more reflections, (or ‘bounces’) between the planar surfaces of the waveguide 408, before being transmitted. FIG. 4 shows a total of nine “bounce” points, BO to B8, along the length of the waveguide 408.

Although light relating to all points of the image (V1-V8) as shown in FIG. 2 is transmitted out of the waveguide at each “bounce” from the second planar surface of the waveguide 408, only the light from one angular part of the image (e.g. light of one of V1 to V8) has a trajectory that enables it to reach the eye 405, from each respective “bounce” point, BO to B8. Moreover, light from a different angular part of the image, V1 to V8, reaches the eye 405 from each respective “bounce” point. Therefore, each angular channel of encoded light reaches the eye only once, from the waveguide 408, in the example of FIG. 4.

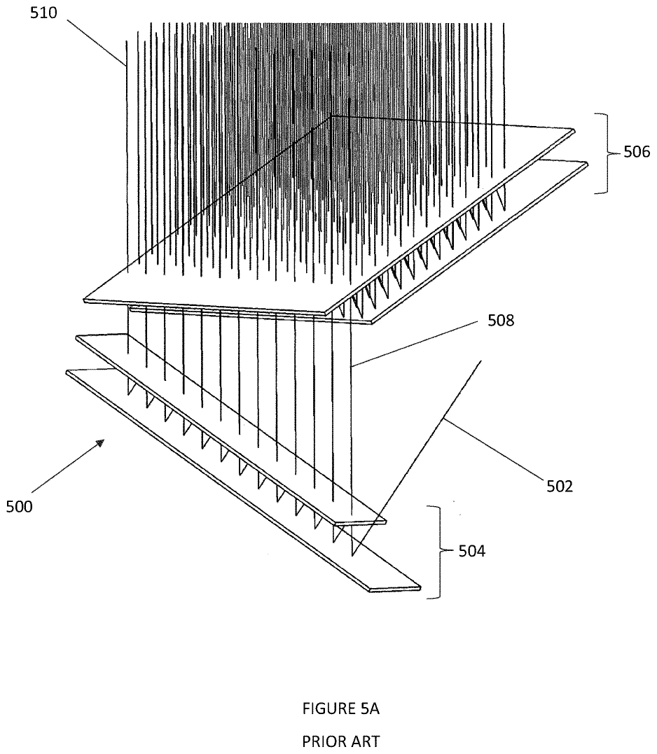

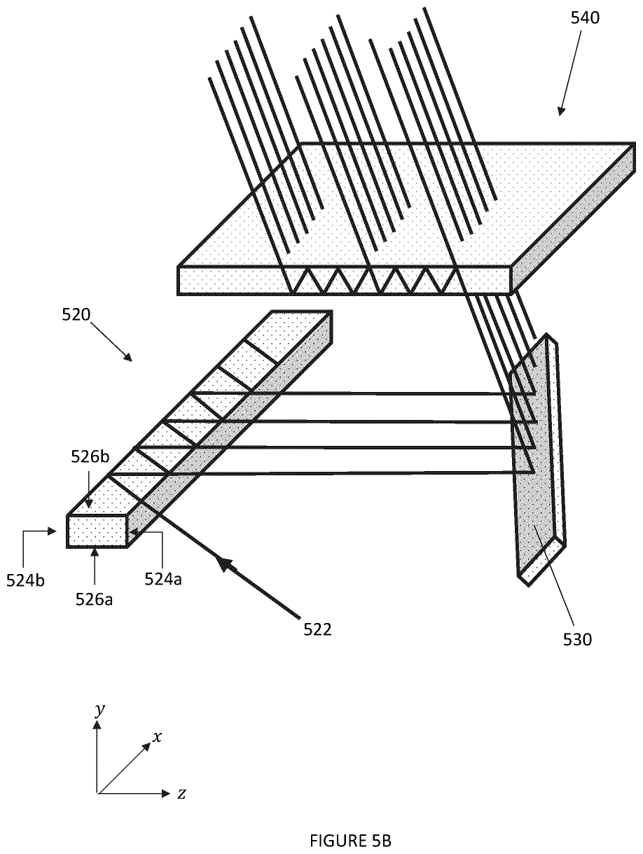

The waveguide 408 forms a plurality of replicas of the hologram, at the respective “bounce” points B1 to B8 along its length, corresponding to the direction of pupil expansion. As shown in FIG. 5, the plurality of replicas may be extrapolated back, in a straight line, to a corresponding plurality of replica or virtual display devices 402′. This process corresponds to the step of “unfolding” an optical path within the waveguide, so that a light ray of a replica is extrapolated back to a “virtual surface” without internal reflection within the waveguide. Thus, the light of the expanded exit pupil may be considered to originate from a virtual surface (also called an “extended modulator” herein) comprising the display device 402 and the replica display devices 402′.

Although virtual images, which require the eye to transform received modulated light in order to form a perceived image, have generally been discussed herein, the methods and arrangements described herein can be applied to real images.

### Two-Dimensional Pupil Expansion

Whilst the arrangement shown in FIG. 4 includes a single waveguide that provides pupil expansion in one dimension, pupil expansion can be provided in more than one dimension, for example in two dimensions. Moreover, whilst the example in FIG. 4 uses a hologram that has been calculated to create channels of light, each corresponding to a different portion of an image, the present disclosure and the systems that are described herebelow are not limited to such a hologram type.

FIG. 5A shows a perspective view of a system 500 comprising two replicators, 504, 506 arranged for expanding a light beam 502 in two dimensions.

In the system 500 of FIG. 5A, the first replicator 504 comprises a first pair of surfaces, stacked parallel to one another, and arranged to provide replication—or, pupil expansion—in a similar manner to the waveguide 408 of FIG. 4. The first pair of surfaces are similarly (in some cases, identically) sized and shaped to one another and are substantially elongate in one direction. The collimated light beam 502 is directed towards an input on the first replicator 504. Due to a process of internal reflection between the two surfaces, and partial transmission of light from each of a plurality of output points on one of the surfaces (the upper surface, as shown in FIG. 5A), which will be familiar to the skilled reader, light of the light beam 502 is replicated in a first direction, along the length of the first replicator 504. Thus, a first plurality of replica light beams 508 is emitted from the first replicator 504, towards the second replicator 506.

The second replicator 506 comprises a second pair of surfaces stacked parallel to one another, arranged to receive each of the collimated light beams of the first plurality of light beams 508 and further arranged to provide replication—or, pupil expansion—by expanding each of those light beams in a second direction, substantially orthogonal to the first direction. The first pair of surfaces are similarly (in some cases, identically) sized and shaped to one another and are substantially rectangular. The rectangular shape is implemented for the second replicator in order for it to have length along the first direction, in order to receive the first plurality of light beams 508, and to have length along the second, orthogonal direction, in order to provide replication in that second direction. Due to a process of internal reflection between the two surfaces, and partial transmission of light from each of a plurality of output points on one of the surfaces (the upper surface, as shown in FIG. 5A), light of each light beam within the first plurality of light beams 508 is replicated in the second direction. Thus, a second plurality of light beams 510 is emitted from the second replicator 506, wherein the second plurality of light beams 510 comprises replicas of the input light beam 502 along each of the first direction and the second direction. Thus, the second plurality of light beams 510 may be regarded as comprising a two-dimensional grid, or array, of replica light beams.

Thus, it can be said that the first and second replicators 504, 505 of FIG. 5A combine to provide a two-dimensional replicator (or, “two-dimensional pupil expander”). Thus, the replica light beams 510 may be emitted along an optical path to an expanded eye-box of a display system, such as a head-up display.

In the system of FIG. 5A, the first replicator 504 is a waveguide comprising a pair of elongate rectilinear reflective surfaces, stacked parallel to one another, and, similarly, the second replicator 504 is a waveguide comprising a pair of rectangular reflective surfaces, stacked parallel to one another. In other systems, the first replicator may be a solid elongate rectilinear waveguide and the second replicator may be a solid planar rectangular shaped waveguide, wherein each waveguide comprises an optically transparent solid material such as glass. In this case, the pair of parallel reflective surfaces are formed by a pair of opposed major sidewalls optionally comprising respective reflective and reflective-transmissive surface coatings, familiar to the skilled reader.

FIG. 5B shows a perspective view of a system 500 comprising two replicators, 520, 540 arranged for replicating a light beam 522 in two dimensions, in which the first replicator is a solid elongated waveguide 520 and the second replicator is a solid planar waveguide 540.

In the system of FIG. 5B, the first replicator/waveguide 520 is arranged so that its pair of elongate parallel reflective surfaces 524a, 524b are perpendicular to the plane of the second replicator/waveguide 540. Accordingly, the system comprises an optical coupler arranged to couple light from an output port of first replicator 520 into an input port of the second replicator 540. In the illustrated arrangement, the optical coupler is a planar/fold mirror 530 arranged to fold or turn the optical path of light to achieve the required optical coupling from the first replicator to the second replicator. As shown in FIG. 5B, the mirror 530 is arranged to receive light—comprising a one-dimensional array of replicas extending in the first dimension—from the output port/reflective-transmissive surface 524a of the first replicator/waveguide 520. The mirror 530 is tilted so as to redirect the received light onto an optical path to an input port in the (fully) reflective surface of second replicator 540 at an angle to provide waveguiding and replica formation, along its length in the second dimension. It will be appreciated that the mirror 530 is one example of an optical element that can redirect the light in the manner shown, and that one or more other elements may be used instead, to perform this task.

In the illustrated arrangement, the (partially) reflective-transmissive surface 524a of the first replicator 520 is adjacent the input port of the first replicator/waveguide 520 that receives input beam 522 at an angle to provide waveguiding and replica formation, along its length in the first dimension. Thus, the input port of first replicator/waveguide 520 is positioned at an input end thereof at the same surface as the reflective-transmissive surface 524a. The skilled reader will understand that the input port of the first replicator/waveguide 520 may be at any other suitable position.

Accordingly, the arrangement of FIG. 5B enables the first replicator 520 and the mirror 530 to be provided as part of a first relatively thin layer in a plane in the first and third dimensions (illustrated as an X-z plane). In particular, the size or “height” of a first planar layer-in which the first replicator 520 is located-in the second dimension (illustrated as the y dimension) is reduced. The mirror 530 is configured to direct the light away from a first layer/plane, in which the first replicator 520 is located (i.e. the “first planar layer”), and direct it towards a second layer/plane, located above and substantially parallel to the first layer/plane, in which the second replicator 540 is located (i.e. a “second planar layer”). Thus, the overall size or “height” of the system—comprising the first and second replicators 520, 540 and the mirror 530 located in the stacked first and second planar layers in the first and third dimensions (illustrated as an x-z plane)—in the second dimension (illustrated as the y dimension) is compact. The skilled reader will understand that many variations of the arrangement of FIG. 5B for implementing the present disclosure are possible and contemplated.

The image projector may be arranged to project a diverging or diffracted light field. In some embodiments, the light field is encoded with a hologram. In some embodiments, the diffracted light field comprises diverging ray bundles. In some embodiments, the image formed by the diffracted light field is a virtual image.

In some embodiments, the first pair of parallel/complementary surfaces are elongate or elongated surfaces, being relatively long along a first dimension and relatively short along a second dimension, for example being relatively short along each of two other dimensions, with each dimension being substantially orthogonal to each of the respective others. The process of reflection/transmission of the light between/from the first pair of parallel surfaces is arranged to cause the light to propagate within the first waveguide pupil expander, with the general direction of light propagation being in the direction along which the first waveguide pupil expander is relatively long (i.e., in its “elongate” direction).

There is disclosed herein a system that forms an image using diffracted light and provides an eye-box size and field of view suitable for real-world application—e.g. in the automotive industry by way of a head-up display. The diffracted light is light forming a holographic reconstruction of the image from a diffractive structure—e.g. hologram such as a Fourier or Fresnel hologram. The use diffraction and a diffractive structure necessitates a display device with a high density of very small pixels (e.g. 1 micrometer)—which, in practice, means a small display device (e.g. 1 cm). The inventors have addressed a problem of how to provide 2D pupil expansion with a diffracted light field e.g. diffracted light comprising diverging (not collimated) ray bundles.

In some embodiments, the display system comprises a display device—such as a pixelated display device, for example a spatial light modulator (SLM) or Liquid Crystal on Silicon (LCOS) SLM—which is arranged to provide or form the diffracted or diverging light. In such aspects, the aperture of the spatial light modulator (SLM) is a limiting aperture of the system. That is, the aperture of the spatial light modulator —more specifically, the size of the area delimiting the array of light modulating pixels comprised within the SLM-determines the size (e.g. spatial extent) of the light ray bundle that can exit the system. In accordance with this disclosure, it is stated that the exit pupil of the system is expanded to reflect that the exit pupil of the system (that is limited by the small display device having a pixel size for light diffraction) is made larger or bigger or greater in spatial extend by the use of at least one pupil expander.

The diffracted or diverging light field may be said to have “a light field size”, defined in a direction substantially orthogonal to a propagation direction of the light field. Because the light is diffracted/diverging, the light field size increases with propagation distance.

In some embodiments, the diffracted light field is spatially-modulated in accordance with a hologram. In other words, in such aspects, the diffractive light field comprises a “holographic light field”. The hologram may be displayed on a pixelated display device. The hologram may be a computer-generated hologram (CGH). It may be a Fourier hologram or a Fresnel hologram or a point-cloud hologram or any other suitable type of hologram. The hologram may, optionally, be calculated so as to form channels of hologram light, with each channel corresponding to a different respective portion of an image that is intended to be viewed (or perceived, if it is a virtual image) by the viewer. The pixelated display device may be configured to display a plurality of different holograms, in succession or in sequence. Each of the aspects and embodiments disclosed herein may be applied to the display of multiple holograms.

The output port of the first waveguide pupil expander may be coupled to an input port of a second waveguide pupil expander. The second waveguide pupil expander may be arranged to guide the diffracted light field—including some of, preferably most of, preferably all of, the replicas of the light field that are output by the first waveguide pupil expander—from its input port to a respective output port by internal reflection between a third pair of parallel surfaces of the second waveguide pupil expander.

The first waveguide pupil expander may be arranged to provide pupil expansion, or replication, in a first direction and the second waveguide pupil expander may be arranged to provide pupil expansion, or replication, in a second, different direction. The second direction may be substantially orthogonal to the first direction. The second waveguide pupil expander may be arranged to preserve the pupil expansion that the first waveguide pupil expander has provided in the first direction and to expand (or, replicate) some of, preferably most of, preferably all of, the replicas that it receives from the first waveguide pupil expander in the second, different direction. The second waveguide pupil expander may be arranged to receive the light field directly or indirectly from the first waveguide pupil expander. One or more other elements may be provided along the propagation path of the light field between the first and second waveguide pupil expanders.

The first waveguide pupil expander may be substantially elongated and the second waveguide pupil expander may be substantially planar. The elongated shape of the first waveguide pupil expander may be defined by a length along a first dimension. The planar, or rectangular, shape of the second waveguide pupil expander may be defined by a length along a first dimension and a width, or breadth, along a second dimension substantially orthogonal to the first dimension. A size, or length, of the first waveguide pupil expander along its first dimension make correspond to the length or width of the second waveguide pupil expander along its first or second dimension, respectively. A first surface of the pair of parallel surfaces of the second waveguide pupil expander, which comprises its input port, may be shaped, sized, and/or located so as to correspond to an area defined by the output port on the first surface of the pair of parallel surfaces on the first waveguide pupil expander, such that the second waveguide pupil expander is arranged to receive each of the replicas output by the first waveguide pupil expander.

The first and second waveguide pupil expander may collectively provide pupil expansion in a first direction and in a second direction perpendicular to the first direction, optionally, wherein a plane containing the first and second directions is substantially parallel to a plane of the second waveguide pupil expander. In other words, the first and second dimensions that respectively define the length and breadth of the second waveguide pupil expander may be parallel to the first and second directions, respectively, (or to the second and first directions, respectively) in which the waveguide pupil expanders provide pupil expansion. The combination of the first waveguide pupil expander and the second waveguide pupil expander may be generally referred to as being a “pupil expander”.

It may be said that the expansion/replication provided by the first and second waveguide expanders has the effect of expanding an exit pupil of the display system in each of two directions. An area defined by the expanded exit pupil may, in turn define an expanded eye-box area, from which the viewer can receive light of the input diffracted or diverging light field. The eye-box area may be said to be located on, or to define, a viewing plane.

The two directions in which the exit pupil is expanded may be coplanar with, or parallel to, the first and second directions in which the first and second waveguide pupil expanders provide replication/expansion. Alternatively, in arrangements that comprise other elements such as an optical combiner, for example the windscreen (or, windshield) of a vehicle, the exit pupil may be regarded as being an exit pupil from that other element, such as from the windscreen. In such arrangements, the exit pupil may be non-coplanar and non-parallel with the first and second directions in which the first and second waveguide pupil expanders provide replication/expansion. For example, the exit pupil may be substantially perpendicular to the first and second directions in which the first and second waveguide pupil expanders provide replication/expansion.

The viewing plane, and/or the eye-box area, may be non-coplanar or non-parallel to the first and second directions in which the first and second waveguide pupil expanders provide replication/expansion. For example, a viewing plane may be substantially perpendicular to the first and second directions in which the first and second waveguide pupil expanders provide replication/expansion.

In order to provide suitable launch conditions to achieve internal reflection within the first and second waveguide pupil expanders, an elongate dimension of the first waveguide pupil expander may be tilted relative to the first and second dimensions of the second waveguide pupil expander.

### Combiner Shape Compensation

An advantage of projecting a hologram to the eye-box is that optical compensation can be encoded in the hologram (see, for example, European patent 2936252 incorporated herein by herein). The present disclosure is compatible with holograms that compensate for the complex curvature of an optical combiner used as part of the projection system. In some embodiments, the optical combiner is the windscreen of a vehicle. Full details of this approach are provided in European patent 2936252 and are not repeated here because the detailed features of those systems and methods are not essential to the new teaching of this disclosure herein and are merely exemplary of configurations that benefit from the teachings of the present disclosure.

### Control Device

The present disclosure is also compatible with optical configurations that include a control device (e.g. light shuttering device) to control the delivery of light from a light channelling hologram to the viewer. The holographic projector may further comprise a control device arranged to control the delivery of angular channels to the eye-box position. British patent application 2108456.1, filed 14 Jun. 2021 and incorporated herein by reference, discloses the at least one waveguide pupil expander and control device. The reader will understand from at least this prior disclosure that the optical configuration of the control device is fundamentally based upon the eye-box position of the user and is compatible with any hologram calculation method that achieves the light channeling described herein. It may be said that the control device is a light shuttering or aperturing device. The light shuttering device may comprise a 1D array of apertures or windows, wherein each aperture or window independently switchable between a light transmissive and a light non-transmissive state in order to control the deliver of hologram light channels, and their replicas, to the eye-box. Each aperture or window may comprise a plurality of liquid crystal cells or pixels.

### Spatial Light Filter

In embodiments, an optical relay is used to form an image of the spatial light modulator (which is also an image of the displayed hologram) at an output plane of the optical relay. By way of non-limiting example, the optical relay may comprise two lens arranged in a telescope configuration. The image of the spatial light modulator may be referred to as the “relayed” spatial light modulator or relayed hologram. The inventors investigated the light profile of the relayed SLM/hologram with a blank or “zero” hologram and a zero-order block at an intermediate focal plane (intermediate holographic replay plane) of the optical relay. The inventors discovered some surprising effects of the zero-order block which they were able to correlate with a decrease in the perceived image quality.

A spatial light filter having a DC order ‘hole’ can be used to remove a bright spot at the centre of an image reconstructed from a hologram at a holographic replay plane. The bright spot may be due to unmodulated light. The DC order ‘hole’ is typically a circular area that blocks light from passing through, and thus from continuing to be transmitted along the optical path of the optical relay or system. As the skilled person will appreciate, if the spatial filter is located a transmissive plane in the optical relay, the circular area blocks light, whilst if the spatial filter is located a reflective plane (e.g., mirror that “folds” the optical path) in the optical relay, the circular area lets light through (instead of reflecting it back onto the optical path). The circular area is referred to herein as a ‘hole’, the ‘hole’ can be thought of as a step function where the inside of the ‘hole’ allows none of the incident light to be transmitted and the outside of the ‘hole’ allows nearly all of the light to be transmitted. These holes are typically less than 1000 microns, such as less than 500 microns. Such a DC order ‘hole’ introduces a dark spot in the reconstructed image so that the central part of the content (which may include a region of desired content) is removed. However, the inventors have identified that a DC order ‘hole’ can adversely affect the quality of the image of the SLM/hologram formed by the optical relay. This, in turn, was found to have a negative effect on the quality of the reconstructed image perceived by the viewer. This observation was surprising because the ‘hole’ should only remove the unmodulated component of the holographic wavefront from the optical path of the optical relay and should not have a significant effect on the modulated component that is encoded with the image information. The magnitude of this effect was particularly surprising to the inventors. The inventors were able to illustrate the effect by studying the amplitude and phase component of the holographic wavefront arriving at the SLM/hologram image formed by the optical relay. This analysis revealed dark spots or bands in the light profile of the SLM image when a “blank” hologram was displayed.

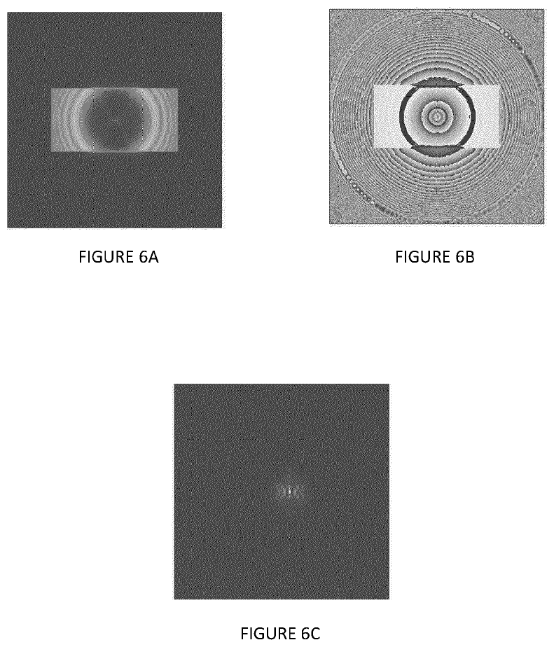

FIG. 6A depicts an intensity plot of light arriving at the image of the hologram (i.e. the relayed hologram) formed by the optical relay when a step-function hole is used in accordance with an inferior configuration to remove the DC order. The light propagating through the DC order ‘hole’ comprises spatially modulated light that was spatially modulated by a spatial light modulator (SLM). The SLM may comprise Liquid Crystal on Silicon. The darkest areas are areas with minimum intensity. The lightest areas are areas with maximum intensity. FIG. 6A shows a rectangular area, which corresponds to the relayed SLM area, having a central circular area corresponding to the DC order hole. This results in a dark circle at the centre of the rectangular area. The central dark circle corresponds to the area that is blocked by a light filter having a DC order ‘hole’. The rectangular area also shows dark bands at periodic positions relative to the centre of the central dark circle which are owing to the DC order hole comprising a step function or stepped edge (i.e. infinite change in transmissivity at the boundary/edge of the ‘hole’).

FIG. 6B depicts the corresponding phase plot of light arriving at the image of the hologram (i.e. the relayed hologram) formed by the optical relay using a step-function DC order hole. The darkest areas are areas with highest phase. The lightest areas are areas with lowest phase. FIG. 6B shows bright and dark bands (i.e. areas of maximum and minimum phase) alternating periodically, starting from the centre. This periodic phase detrimentally affects the holographic picture as seen by the viewer.

FIG. 6C depicts an intensity plot of the image reconstructed from light of the blank or “zero” hologram propagating through a step-function DC order hole, i.e. the holographic picture as seen by the viewer. The darkest areas are areas with maximum intensity. The lightest areas are areas with minimum intensity. FIG. 6C shows that the viewer would see bright and dark bands periodically, starting from the centre FIGS. 6A-C therefore show that a DC block comprising a stepped or infinite gradient edge has a negative effect on the reconstruction image owing to a negative effect on the relayed hologram.

The inventors have surprisingly found that instead of a sharp cut-off in the transmission of the DC order ‘hole’, an apodised hole or a hole having a gaussian profile (which results in a gradual decrease in transmission from the edge of the hole to its centre) can be sufficient to mitigate and/or reduce the negative impact of using a DC order block or ‘hole’. In other words, a spatial light filter comprises a portion that has a transmissivity that increases as a continuous function of distance relative to a centre of the portion can be used to mitigate/reduce those periodic artefacts.

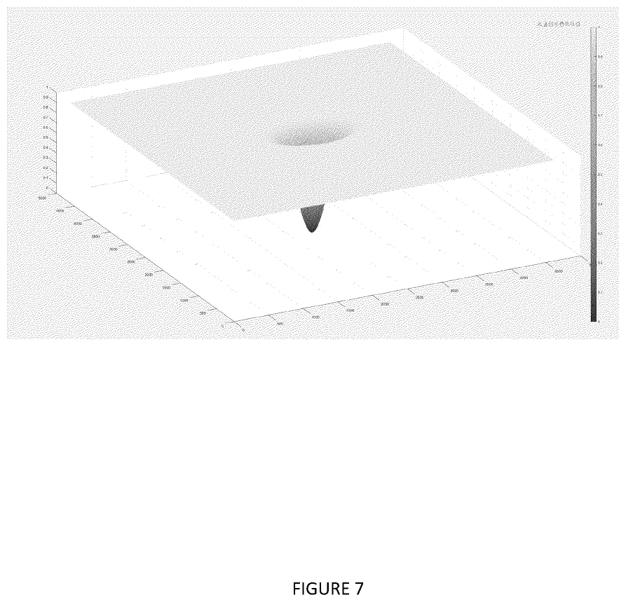

FIG. 7 depicts a transmission profile of a spatial light filter having a Gaussian hole or a hole having a Gaussian profile. The darkest areas of the spatial light filter correspond to areas of minimum transmissivity. The transmissivity increases as a Gaussian function of the distance relative to the centre of the hole. The lightest areas of the spatial light filter correspond to areas of maximum transmissivity. In this embodiment, the Gaussian profile is elliptical in shape. The transmissivity in the centre of the hole is a minimum value of Gaussian function, e.g. 0% transmission or 10% transmission. The transmissivity increases according to a Gaussian equation. The transmission profile of the spatial filter shown in FIG. 7 is suitable for use at a transmissive plane of the optical relay. As the skilled person will appreciate, the transmission profile of a spatial filter for use at a reflective plane (e.g. mirror) of the optical relay would have an inverse profile, whereby transmissivity is a maximum at the centre of the hole and decreases as a Gaussian function of the distance relative to the centre of the hole.

The block or hole of the spatial light filter can have a transmission profile other than Gaussian. In other embodiments, the hole of the spatial light filter has a non-linear continuous profile that is not Gaussian. In some embodiments, the hole may have a non-symmetrical profile.

To create a Gaussian hole, a graded absorption coating can be applied to a piece of glass to be placed in the intermediate focal plane of the optical relay, which may be in front of a mirror. The coating has strongest absorption in the centre of the Gaussian hole. Specifically, a spatial light filter can be manufactured by applying a light absorbing coating having a first transmissivity onto a material having a second transmissivity higher than the first transmissivity. The application of the light absorbing coating is such that the resulting spatial light filter has a hole that has a transmissivity that increases as a continuous function of distance relative to a centre of the hole. For example, the amount of light absorbing coating may be greater at areas that are closer to the centre of the hole.

In an alternative arrangement, a reflective spatial light filter may be implemented. Such a filter may be manufactured by applying a coating to a material, the coating material creating a reflective surface. The application of the coating is such that the spatial light filter has a portion that has a reflectivity that changes (e.g., increases or decreases) as a continuous function of distance relative to a centre of the portion. For example, the amount of the reflectance material may be greater at areas that are closer to the centre of the hole. In other words, the filter mirror can be manufactured with a graded reflectance coating that simulates the same Gaussian fall-off in transmitted intensity as that achieved by the above-described spatial light filter. A reflective spatial light filter may be implemented as a fold mirror at an intermediate focal plane of the optical relay, in which the reflectivity is a maximum outside the hole and decreases towards the centre as a continuous function of distance. In the case that the mirror is a reflective coating on glass, the light at the centre will be transmitted through the glass, rather than reflective, and thus removed or blocked from transmission along the optical path.

The above-described methods can also be used to form spatial light filter that is in the form of a thin slit rather than a bright spot and/or circle.

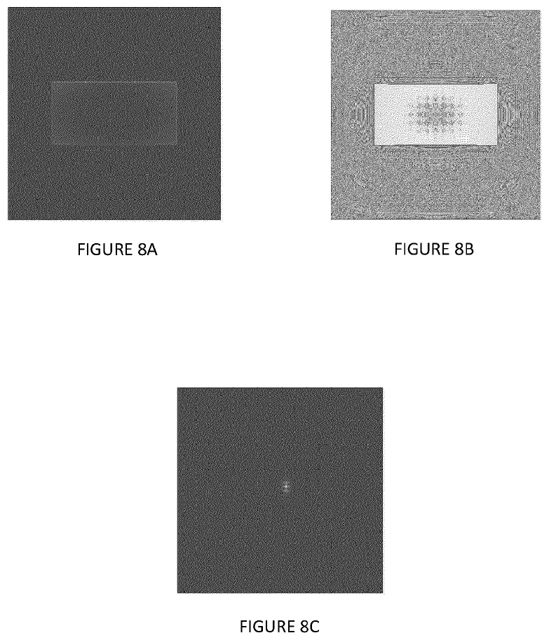

FIG. 8A depicts an intensity plot of light arriving at the image of the hologram (i.e. the relayed hologram) formed by the optical relay through a spatial light filter having an elliptical Gaussian hole in accordance with some embodiments. The light propagating through the Gaussian hole may be spatially modulated light. In contrast to the setup shown in FIG. 6A, the intensity plot of FIG. 8A does not show any periodic dark bands when used in a holographic projection system comprising an optical relay for forming an image of the hologram.

FIG. 8B depicts a phase plot of light arriving at the image of the hologram (i.e. the relayed hologram) formed by the optical relay through the spatial light filter having an elliptical Gaussian hole. The light propagating through the Gaussian hole may be spatially modulated light. In contrast to FIG. 6B, the phase plot of FIG. 8B does not show any periodic dark bands of (i.e. areas of maximum and minimum phase retardation) when used in the holographic projection system of the present disclosure.

FIG. 8C depicts an intensity plot of the image reconstructed from light of the blank or “zero” hologram propagating through an elliptical Gaussian hole in accordance with some embodiments, i.e. the holographic picture as seen by the viewer. The light propagating through the Gaussian hole may be spatially modulated light. The reconstructed image/picture of FIG. 8C does not show the artefacts of FIG. 6C.

As such, a spatial light filter having a Gaussian hole advantageously improves the holographic pictures as seen by a viewer. This is because the image artifacts with conventional spatial light filters are substantially removed.

### Additional Features

The methods and processes described herein may be embodied on a computer-readable medium. The term “computer-readable medium” includes a medium arranged to store data temporarily or permanently such as random-access memory (RAM), read-only memory (ROM), buffer memory, flash memory, and cache memory. The term “computer-readable medium” shall also be taken to include any medium, or combination of multiple media, that is capable of storing instructions for execution by a machine such that the instructions, when executed by one or more processors, cause the machine to perform any one or more of the methodologies described herein, in whole or in part.

The term “computer-readable medium” also encompasses cloud-based storage systems. The term “computer-readable medium” includes, but is not limited to, one or more tangible and non-transitory data repositories (e.g., data volumes) in the example form of a solid-state memory chip, an optical disc, a magnetic disc, or any suitable combination thereof. In some example embodiments, the instructions for execution may be communicated by a carrier medium. Examples of such a carrier medium include a transient medium (e.g., a propagating signal that communicates instructions).

It will be apparent to those skilled in the art that various modifications and variations can be made without departing from the scope of the appended claims. The present disclosure covers all modifications and variations within the scope of the appended claims and their equivalents.

1. A holographic projector configured to provide a holographic picture at an output plane, the holographic projector comprising:
a spatial light modulator configured to display a hologram such that light incident on the displayed hologram is spatially modulated according to the displayed hologram;
an optical relay arranged to receive the spatially modulated light, the optical relay comprising a pair of lenses arranged in cooperation to form the holographic picture at the output plane; and
a spatial light filter comprising a portion arranged to receive the spatially modulated light, wherein the portion has a transmissivity that changes as a continuous function of distance relative to a center of the portion, and wherein the portion is elliptical in shape.

2. The holographic projector of claim 1, further comprising a further portion, wherein at least one of (i) the further portion has a further transmissivity that is substantially constant, or (ii) the further portion has a further transmissivity that is a maximum or minimum value of the continuous function.

3. The holographic projector of claim 1, wherein at least one of (i) the function has a maximum rate of change of transmissivity that is less than or equal to 10% per 100 microns, or (ii) the function has a maximum rate of change of transmissivity is less than or equal to 5% per 100 microns.

4. The holographic projector of claim 1, wherein the spatial light filter is arranged to transmit the spatially modulated light to the output plane.

5. The holographic projector of claim 1, wherein the spatial light filter is arranged to reflect the spatially modulated light to the output plane, and wherein the portion arranged to receive the spatially modulated light has a reflectivity that increases as a continuous function of distance relative to a center of the portion arranged to receive the spatially modulated light.

6. The holographic projector of claim 5, further comprising a further portion, wherein at least one of (i) the further portion has a further reflectivity that is substantially constant, or (ii) the further portion has a further reflectivity that is a maximum value of the continuous function.

7. The holographic projector of claim 5, wherein at least one of (i) the function has a rate of change of reflectivity that is less than or equal to 10% per 100 microns, or (ii) the the function has a rate of change of reflectivity that is less than or equal to 5% per 100 microns.

8. The holographic projector of claim 1, wherein at least one of (i) the continuous function is nonlinear, or (ii) the continuous function is a Gaussian function.

9. (canceled)

10. The holographic projector of claim 1, wherein the spatial light filter is positioned at a focal plane of one lens of the pair of lenses.

11. The holographic projector of claim 1, wherein the spatial light filter is arranged to prevent a portion of the spatially modulated light from propagating to the output plane of the optical relay.

12. The holographic projector of claim 11, wherein the portion of the spatially modulated light corresponds to one of (i) a non-picture content of the spatially modulated light, or (ii) unmodulated light from the spatial light modulator.

13. The holographic projector of claim 1, further comprising at least one waveguide arranged to receive the spatially modulated light.

14. A method of manufacturing a spatial light filter for a holographic projector, the method comprising:
applying a light absorption coating having a first transmissivity onto a material having a second transmissivity higher than the first transmissivity, wherein application of the light absorption coating is such that the spatial light filter has comprises (i) a portion that has a transmissivity that increases as a continuous function of distance relative to a center of the portion, wherein the portion is elliptical in shape and, (ii) a further portion that has a further transmissivity that is substantially constant.

15. The method of claim 14, wherein portions of lower transmissivity have a larger amount of the absorption coating applied thereon.

16. A method of manufacturing a spatial light filter, the method comprising:
applying a coating to a material, the coated material creating a reflective surface, wherein application of the coating is arranged such that the spatial light filter has a portion that has a reflectivity that increases as a continuous function of distance relative to a center of the portion, and wherein the portion is elliptical in shape.

17. The method of claim 16, wherein portions of lower reflectance have a lower amount of the reflectance coating applied thereon.

18. The method of claim 16, wherein the material is glass.

19. A spatial light filter comprising:
a first portion that has a transmissivity that increases as a continuout function of distance relative to a center of the portion, wherein the first portion is elliptical in shape;
a second portion that has a further transmissivity that is substantially constant; and
wherein the first portion and the second portion are formed by applying a light absorption coating having a first transmissivity onto a material having a second transmissivity higher than the first transmissivity.
